(19) United States
(12) Patent Application Publication
(10) Pub. No.: US 2024/0298212 A1
(43) Pub. Date: Sep. 5, 2024

(54) METHOD FOR SECURING COMMUNICATION BETWEEN A ROADSIDE RADIO UNIT AND VEHICLES, COMPUTER PROGRAM AND SYSTEM FOR SUPPORTING VEHICLES, METHOD FOR MONITORING THE ROADSIDE RADIO UNIT, AND MONITORING UNIT

(71) Applicant: Robert Bosch GmbH, Stuttgart (DE)

(72) Inventors: Tobias FRYE, Braunschweig (DE); Holger Mindt, Steinheim A. D. Murr (DE)

(21) Appl. No.: 18/549,677

(22) PCT Filed: Aug. 8, 2022
(86) PCT No.: PCT/EP2022/072232

§ 371 Date: Sep. 8, 2023

(30) Foreign Application Priority Data
Aug. 11, 2021 (DE) 10 2021 208 802.3

(51) Int. Cl. H04W 28/04; H04L 1/08

(52) U.S. Cl. CPC H04W 28/04; H04L 1/08

(57) ABSTRACT

A method for securing communication between a roadside radio unit and vehicles in the surroundings of the roadside radio unit. The method includes: broadcasting a sequence of radio signals to the surroundings by means of the roadside radio unit, wherein the radio signals each have a temporal assignment; receiving a response signal from a vehicle or a stationary monitoring unit, wherein the response signal represents at least the temporal assignment of a radio signal that was faulty or not received by the vehicle or by the monitoring unit; and broadcasting a repeated signal by means of the roadside radio unit as a function of the received response signal, wherein the repeated signal represents the faulty or not-received radio signal and is in particular characterized as a repeated signal.

### FIELD

The present invention relates to methods for securing communication between a roadside radio unit and vehicles in the surroundings of the roadside radio unit. The present invention also relates to a system for supporting vehicles, in particular vehicles driving in a highly automated manner. The present invention furthermore relates to a computer program comprising instructions that, when the program is executed by a computer, cause the computer to perform the method according to the present invention. The present invention also relates to a method for monitoring the roadside radio unit and to a monitoring unit.

### BACKGROUND INFORMATION

Systems for supporting vehicles through communication between roadside radio units and vehicles are generally described in the related art. For example, V2X communication, wherein the communication comprises a transmission and reception protocol. The communication between roadside radio units and vehicles is to increase road safety, lead to energy savings, and/or enhance traffic efficiency. For the communication, there are in principle two different communication connections or transmission modes. The first communication connection or transmission mode is wireless direct communication, e.g., a WLAN standard for cars (e.g., DSRC/ITS-G5) or cellular V2X (such as LTE-V, 5G-V2X).

Wireless direct communication, e.g., the WLAN standard, results in low latency for the transmitting signals but has a maximum range of only a few hundred meters or has a short range in comparison to a mobile radio connection. The WLAN standard IEEE 802.11p is advantageously used in the frequency band of 5.85 to 5.925 GHz. Clocking between radio signals messages may be between 1-10 Hz. A temporal assignment of a respective radio signal for wireless direct communication may, for example, comprise a sequential numbering and/or a current time and/or date indication. For example, vehicles may approach an intersection with a traffic light, whereupon, based on a wireless direct communication, e.g., a WLANp radio signal of the vehicle, the traffic light sets a green phase for the approaching vehicle so that traffic flow is less disrupted. The second transmission mode is via mobile radio. The participating vehicles must have SIM cards installed for this purpose, wherein the transmission time between a transmitter, a cloud or a server device and a receiver is generally longer than that of the WLAN connection and is usually less than 3 seconds.

German Patent Application No. DE 60 036 530 T2 describes a communication system.

German Patent Application No. DE 11 2012 005 853 T5 describes a driving assistance device.

European Patent No. EP 2 229 668 B1 describes a transmission of vehicle-relevant data of a vehicle via mobile communication.

China Patent Application No. CN 111970661 A describes a method for improving the reliability of V2X communication.

U.S. Patent Application Publication No. US 2016/148512 A1 describes a system for transmitting traffic-relevant messages.

U.S. Patent Application Publication No. US 2011/191011 A1 describes communication between local entities for optimizing a transport network.

An object of the present invention is to secure a communication connection or communication between a roadside radio unit (RSU) and a vehicle.

### SUMMARY

The above object may be achieved according to the present invention.

The present invention relates to a method for securing communication between a roadside radio unit and a vehicle or vehicles in the surroundings of the roadside radio unit. According to an example embodiment of the present invention, the method comprises broadcasting a sequence of radio signals to the surroundings by means of the roadside radio unit (RSU). The broadcast radio signals each have a temporal assignment. Advantageously, the radio signals are broadcast in a specified time sequence or in a predetermined clocking or with fixed intervals between two radio signals. The optional clocking, or the intervals between two radio signals, may alternatively be variable. The broadcast radio signals are preferably radio signals for direct communication, in particular ITS-G5 or WLAN radio signals or cellular V2X radio signals. It may optionally be provided that in addition to the radio signal, the roadside radio unit sends a cable-based expected value signal to the monitoring unit. The optional expected value signal may, for example, comprise information on the current temporal assignment, the specified time sequence, or the predetermined clocking, or the variable clocking. Subsequently, the roadside radio receives a response signal from a vehicle or a stationary monitoring unit. The response signal represents at least the temporal assignment of a radio signal not received by the vehicle or the monitoring unit or a faulty radio signal. In other words, the vehicle or the monitoring unit advantageously has ascertained a faulty or missing radio signal as a function of the temporal assignment and optionally as a function of the specified time sequence of the radio signals. The monitoring unit may optionally additionally ascertain a faulty or missing radio signal as a function of the broadcast cable-based expected value signal. The response signal is in particular transmitted by the vehicle or the stationary monitoring unit to the roadside radio unit by means of a separate radio connection and/or by means of a mobile radio connection to a server unit. The separate radio connection is based in particular on a different radio frequency. Preferably, it may be provided that the response signal is alternatively or additionally sent or transmitted by means of a cable connection from the stationary monitoring unit to the roadside radio unit or to the server unit and subsequently to the roadside radio unit. The cable connection is in particular based on a cable between the roadside radio unit and the monitoring unit. In other words, the response signal is advantageously transmitted to the roadside radio unit via a different communication connection or transmission mode since the vehicle or the monitoring unit in particular already have ascertained a fault in the communication connection of the sequence of radio signals since a radio signal has been determined to be faulty or missing at least as a function of the temporal assignment. Subsequently, as a further method step, a repeated signal is broadcast by means of the roadside radio unit as a function of the received response signal, wherein the repeated signal represents the not-received radio signal and is advantageously marked as a repeated signal. The repeated signal is preferably a radio signal for direct communication, in particular an ITS-G5 or WLAN radio signal or a cellular V2X radio signal. Alternatively or additionally, the repeated signal may be sent via the mobile radio. Broadcasting can advantageously take place outside of the specified time sequence or in the specified time sequence. The method has the advantage that the radio signals for direct communication between the roadside radio unit are reliably broadcast to the vehicle or vehicles in the surroundings of the roadside radio unit since the repeated signal is broadcast in the event of a faulty or not-received WLAN radio signal. In other words, the reliability and/or availability of the communication is thereby increased so that receiving all broadcast radio signals to the vehicle or vehicles in the surroundings of the roadside radio unit becomes more likely.

In an advantageous embodiment of the present invention, the reception of the response signal is checked for plausibility based on the time of reception of the response signal and/or the temporal assignment of the not-received radio signal. This filters non-logical response signals so that the method is less prone to undesirable interferences.

In a further embodiment of the present invention, the repeated signal is loaded from a memory of the roadside radio unit as a function of the response signal. As a result, a repeated signal is advantageously also generated based on response signals received relatively late.

Alternatively, according to an example embodiment of the present invention, the repeated signal comprises the last broadcast radio signal. In this embodiment, both the broadcast sequence of the radio signals and the repeated signal are preferably wireless direct communication signals, e.g., WLAN signals. In this embodiment, the response signal is preferably sent from the monitoring unit to the roadside radio unit by means of a cable.

Preferably, according to an example embodiment of the present invention, broadcasting the repeated signal is carried out with an increased transmit power in comparison to the sequence of radio signals. As a result, the reception of the repeated signal by the vehicle or vehicles in the surroundings of the roadside radio unit becomes more likely.

In a continuation, according to an example embodiment of the present invention, it may be provided that the transmit power for broadcasting the sequence of radio signals to the surroundings is adjusted as a function of the received response signal. The adjustment of the transmit power may take place for a specified time period or may slowly subside. As a result, the reception of the radio signals by the vehicle or vehicles in the surroundings of the roadside radio unit becomes more likely in the case of a recognized, not-received radio signal, for example in poor weather conditions or heavy traffic. The transmit power is thus adjusted or increased in this continuation only as needed, so that the method is carried out more efficiently or in a more energy-saving manner.

In another example embodiment of the present invention, the repeated signal can be broadcast with a different modulation method (e.g., in WLAN-based systems) or a different resource block in semi-persistent scheduling (e.g., in cellular V2X or C-V2X-based systems). This reduces the likelihood of a further transmission error.

In another example embodiment of the present invention, the repeated signal can be broadcast at a different radio frequency or by means of a mobile radio connection to a server unit. In other words, it may be provided that the repeated signal is transmitted via a different communication connection or transmission mode between the roadside radio unit and the vehicle or vehicles, for example by means of a mobile radio connection or at a different radio frequency in comparison to the faulty or not-received radio signal. As a result, the reception of the repeated signal by the vehicle or vehicles in the surroundings of the roadside radio unit becomes more likely in the case of a recognized, faulty or not-received radio signal, even if the latency increases for this repeated signal.

In addition, in an alternative example embodiment of the present invention, it may be provided that the radio frequency for broadcasting the sequence of radio signals to the surroundings is adjusted as a function of the received response signal or that the radio signal is broadcast to a server unit by means of the mobile radio connection. As a result, the reception of the radio signals by the vehicle or vehicles in the surroundings of the roadside radio unit becomes more likely in the case of a recognized, faulty or not-received radio signal, even if the latency for the broadcast radio signals may increase.

In an alternative development of the present invention, in the method, the roadside radio unit is restarted or switched off or problem information is automatically sent to a server unit as a function of a response signal or of a sequence of response signals of the monitoring unit or of the vehicle. By means of this development, a system error can be eliminated.

The present invention also relates to a computer program. The computer program comprises instructions that, when the program is executed by a computer, cause the computer to perform the steps of the method according to the present invention.

The present invention furthermore relates to a system for supporting vehicles, comprising a roadside radio unit. According to an example embodiment of the present invention, the roadside radio unit is configured to broadcast radio signals with a temporal assignment by means of a transmitting device. Preferably, the roadside radio unit may be configured to broadcast the radio signals by means of the transmitting device in the specified time sequence or with the specified clocking. The roadside radio unit is also configured to receive, by means of a radio-based or cable-based reception interface, the response signal from a vehicle or a monitoring unit, wherein the response signal represents at least the temporal assignment of a radio signal that was faultily or not received by the vehicle or monitoring unit. Furthermore, the roadside radio unit is configured to broadcast the repeated signal by means of the transmitting device as a function of the received response signal, wherein the repeated signal represents the faultily received or not-received radio signal and is in particular marked as a repeated signal. The system according to the present invention for supporting vehicles has the advantages of the method according to the present invention for securing the communication between the roadside radio unit and a vehicle or vehicles in the surroundings.

Preferably, according to an example embodiment of the present invention, the system additionally comprises the vehicle and/or the monitoring unit. The vehicle and/or the monitoring unit are each configured to receive the broadcast radio signals of the roadside radio unit by means of a receiving device. The vehicle and/or the monitoring unit are also each configured to send the response signal, at least comprising the temporal assignment of the faultily received or not-received radio signal, to the roadside radio unit by means of a radio-based and/or cable-based transmission interface and/or by means of a mobile radio connection to a server unit, in particular if a radio signal expected in the specified time sequence is faultily or not received.

According to an example embodiment of the present invention, it may furthermore be provided that the roadside radio unit is configured to check the response signal for plausibility based on the time of reception of the response signal and/or the temporal assignment of the faulty or not-received radio signal by means of a computing unit.

In a further example embodiment of the present invention, the roadside radio unit is configured to load the repeated signal from a memory of the roadside radio unit as a function of the response signal.

In another example embodiment of the present invention, the transmitting device of the roadside radio unit is configured to broadcast the repeated signal with an increased transmit power in comparison to the radio signals.

In addition, according to an example embodiment of the present invention, it may be provided that the transmitting device of the roadside radio unit is configured to adjust the transmit power for broadcasting the sequence of radio signals to the surroundings as a function of the received response signal, in particular for a specified time period, wherein, in particular, a temporally varying transmit power results.

In an advantageous example embodiment of the present invention, the transmitting device of the roadside radio unit is configured to broadcast the repeated signal at a different radio frequency in comparison to the radio signals or to broadcast it to a server unit by means of a mobile radio connection.

In another continuation, according to an example embodiment of the present invention, the transmitting device of the roadside radio unit is configured to adjust the radio frequency for broadcasting the sequence of radio signals to the surroundings as a function of the received response signal or to send the sequence of radio signals to a server unit by means of a mobile radio connection as a function of the received response signal.

The present invention also relates to a method for monitoring the roadside radio unit by means of a monitoring unit. According to an example embodiment of the present invention, the method comprises receiving the sequence of broadcast radio signals from the roadside radio unit, wherein the received radio signals each have a temporal assignment. The method for monitoring also comprises recognizing a faulty or not-received radio signal. Recognizing a faulty or not-received radio signal advantageously takes place if a time duration threshold value has been exceeded since the last reception of a broadcast radio signal and/or if a sequential numbering between the radio signals is incomplete and/or if a cryptographic signature of the radio signal is faulty. In addition, a response signal is subsequently generated or sent as a function of the recognized, faulty or not-received radio signal, in particular by means of a mobile radio connection, wireless direct communication connection or cable connection between the monitoring unit and the roadside radio unit, wherein the response signal represents at least the temporal assignment of the recognized, faulty or not-received radio signal.

The present invention also relates to a monitoring unit. According to an example embodiment of the present invention, the monitoring unit comprises a receiving device configured to receive the sequence of the radio signals broadcast by the roadside radio unit. Furthermore, the monitoring unit comprises a computing unit. The computing unit is configured to check the radio signals received by means of the receiving device, wherein the computing unit recognizes, based on the specified time sequence of the radio signals and/or the temporal assignment of the radio signals and/or the expected value signal, whether a radio signal broadcast by the roadside radio unit was faultily or not received by means of the receiving device. The monitoring unit is furthermore configured, by means of a transmission unit, to generate or send the response signal, in particular by means of a mobile radio connection, a wireless direct communication connection and/or a cable connection between the monitoring unit and the roadside radio unit, wherein the response signal represents at least the temporal assignment of the not-received or faultily received radio signal.

Further advantages emerge from the following description of exemplary embodiments with reference to the figures.

### BRIEF DESCRIPTION OF THE DRAWINGS

FIG. 1 shows roadside radio unit, according to an example embodiment of the present invention.

FIG. 2 shows a monitoring unit, according to an example embodiment of the present invention.

FIG. 3 shows a vehicle, according to an example embodiment of the present invention.

FIG. 4A shows a first system example, according to the present invention.

FIG. 4B shows a second system example, according to the present invention.

FIG. 5 shows a method flow for securing a V2X communication, according to an example embodiment of the present invention.

### DETAILED DESCRIPTION OF EXAMPLE EMBODIMENTS

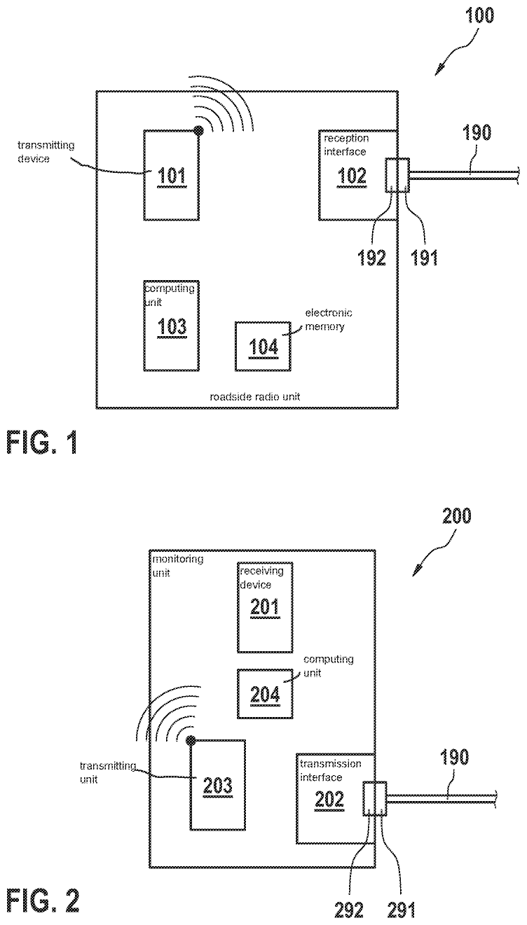

FIG. 1 schematically shows a roadside radio unit 100. The roadside radio unit 100 comprises a transmitting device 101 and a mobile-radio-based, radio-based, and/or cable-based reception interface 102. The reception interface 102 may, for example, comprise a socket 192. Furthermore, the roadside radio unit 100 comprises an optional computing unit 103 and an optional electronic memory 104. The transmitting device 101 is configured to broadcast or generate a sequence of radio signals to the surroundings, in particular by means of an antenna, preferably by means of a WLAN antenna. The transmitting device 101 is preferably configured to generate or broadcast WLANp radio signals as radio signals.

Alternatively, the radio signals are mobile radio signals to a server device 410. The transmitting device 101 is configured to broadcast or generate the radio signals with a temporal assignment and advantageously in an optional specified time sequence. For this purpose, the broadcast radio signals, for example, comprise a sequential numbering and/or date information and/or time information, and optionally information on the specified time sequence or clocking. The transmitting device 101 is furthermore configured to broadcast a repeated signal as a function of a received response signal. The repeated signal represents a radio signal that was faultily or not received by a vehicle 300 or a monitoring unit 200 and is in particular marked as a repeated signal compared to the other radio signals. The repeated signal can be broadcast by means of the transmitting device 101 to a server device 410 at a differing radio frequency compared to the radio signals or by means of a mobile radio connection. The mobile-radio-based, radio-based, and/or cable-based reception interface 102 of the roadside radio unit 100 is configured to receive the response signal of the vehicle 300 or of the monitoring unit 200 with a different transmission mode in comparison to the broadcast radio signals. For example, the radio signals are broadcast according to the WLANp standard or as WLAN signals by means of the transmitting device 101. The reception interface 102 is then configured, for example, to receive a cable-based response signal from the monitoring unit 200 or a mobile radio signal from the vehicle 300 as the response signal. In other words, the response signal is generated, for example, by the monitoring unit 200 and transmitted by means of the cable 190 and the plug 191 to the socket 192 of the reception interface 102. The computing unit 103 is optionally configured to check or validate the response signal, for example as a function of a temporal assignment of a radio signal that was not received by the vehicle 300 or by the monitoring unit 200 and/or as a function of a signature in the response signal, the signature comprising information on the authorization of the vehicle 300 or of the monitoring unit 200 to broadcast the response signal. The roadside radio unit 100 furthermore comprises the optional electronic memory 104. In a continuation, the roadside radio unit 100 is configured to load, based on the response signal, a not-received radio signal from the memory 104.

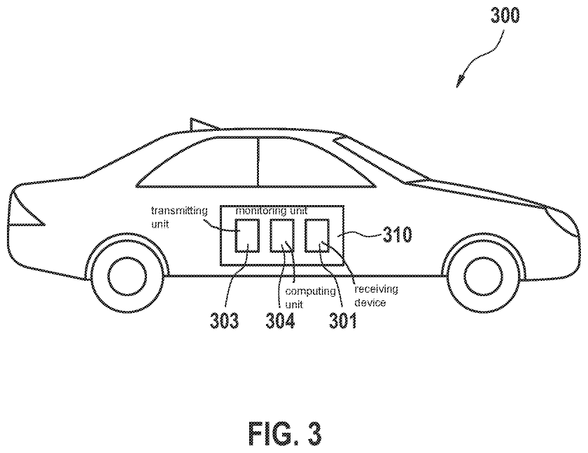

FIG. 2 schematically shows a monitoring unit 200. The monitoring unit 200 comprises a receiving device 201 and a radio-based or cable-based transmission interface 202 as well as an optional transmitting unit 203 for a mobile radio connection to a server unit 410. Furthermore, the monitoring unit 200 comprises an optional computing unit 204 for checking the radio signals received by means of the receiving device 201. The receiving device 201 is configured to receive the sequence of radio signals broadcast by the transmitting device 101 of the roadside radio unit 100. For this purpose, the receiving device 201 in particular comprises an antenna, preferably a WLAN antenna. It may optionally be provided that the receiving device 201 is configured to receive a cable-based expected value signal sent by the roadside radio unit 100. The optional expected value signal may, for example, comprise information on the current temporal assignment, the specified time sequence, or the predetermined clocking, or the variable clocking. The computing unit 204 of the monitoring unit 200 is configured to recognize, based on the specified time sequence of the radio signals and/or the temporal assignment of the radio signals and/or the expected value signal, whether a radio signal broadcast by the roadside radio unit 100 was faultily or not received by means of the receiving device 201. For this purpose, the monitoring unit 200 can retrieve, in particular at regular intervals, the specified time sequence of the radio signals and/or the temporal assignment of current radio signals from the roadside radio unit 100 or the server unit 410. In other words, the monitoring unit 200 can synchronize with the roadside radio unit 100 to exchange the specified time sequence of the radio signals and/or the temporal assignment of current radio signals. If the computing unit 204 of the monitoring unit 200 recognizes that a radio signal expected in the specified time sequence has not been received, the monitoring unit 200 is configured to send the response signal, at least comprising the temporal assignment of the not-received radio signal, to the roadside radio unit 100 by means of the radio-based or cable-based transmission interface 202 to the roadside radio unit 100. The response signal is preferably sent or transmitted from the monitoring unit 200 by means of a socket 292 of the transmission interface 202 to a plug 291 of the cable 190 to the roadside radio unit 100. Alternatively, the response signal may be generated by means of the transmitting unit 203 for a mobile radio connection and transmitted to a server unit 410 and to the roadside radio unit 100.

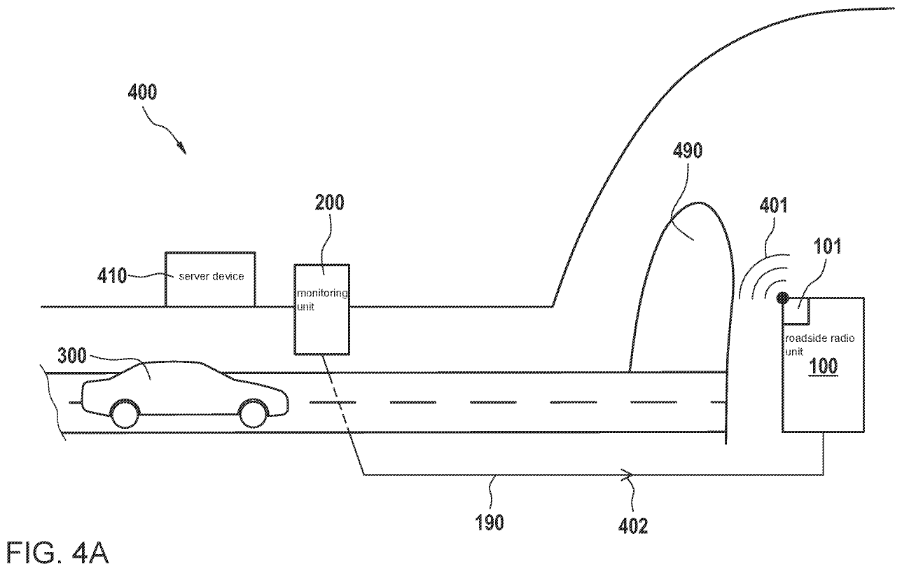

FIG. 3 schematically shows a vehicle 300. The vehicle comprises a monitoring unit 310 of the vehicle 300, similar to FIG. 2, wherein the monitoring unit 310 of the vehicle 300 does not have a cable-based transmission interface 202. The monitoring unit 310 of the vehicle 300 comprises a receiving device 301 and a transmitting unit 303 for a mobile radio connection to a server unit 410. Furthermore, the monitoring unit 310 of the vehicle 300 comprises a computing unit 304 for checking the radio signals received by means of the receiving device 301. Optionally, a radio-based transmission interface 302 may be provided, which is configured, for example, to broadcast WLANp radio signals of the monitoring unit 310 of the vehicle 300 to the roadside radio unit 100. The receiving device 301 is configured to receive the sequence of radio signals broadcast by the transmitting device 101 of the roadside radio unit 100. The computing unit 304 of the monitoring unit 310 of the vehicle 300 is configured to recognize, based on the specified time sequence of the radio signals and/or the temporal assignment of the radio signals, if a radio signal broadcast by the roadside radio unit 100 was faultily or not received by means of the receiving device 301. For this purpose, the monitoring unit 310 of the vehicle 300 can retrieve, in particular at regular intervals, the specified time sequence of the radio signals and/or the temporal assignment of current radio signals from the roadside radio unit 100 or the server unit 410. In other words, the monitoring unit 310 of the vehicle 300 can synchronize with the roadside radio unit 100 to exchange the specified time sequence of the radio signals and/or the temporal assignment of current radio signals. If the computing unit 304 of the monitoring unit 310 of the vehicle 300 recognizes that a radio signal expected in the specified time sequence was faultily or not received, the monitoring unit 310 is configured to generate the response signal, at least comprising the temporal assignment of the not-received radio signal, to the roadside radio unit 100 by means of the transmitting unit 303 for a mobile radio connection. In other words, the response signal in this example is sent by means of the transmitting unit 303 of the monitoring unit 310 of the vehicle 300 via a mobile radio connection to a server unit 410 and to the roadside radio unit 100.

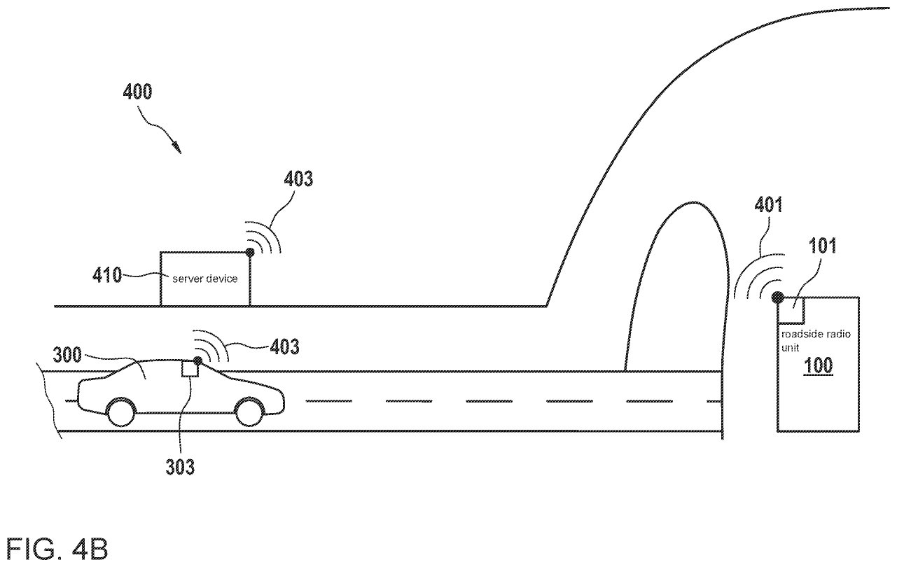

FIG. 4A schematically shows a first system example with a system 400 for supporting vehicles 300 at an entry of a tunnel 490. For example, the roadside radio unit 100 is configured, by wireless direct communication via WLAN radio signals with the vehicles 300, to exchange information with the vehicles 300, in particular information about critical events or situations (e.g., construction site or tunnel) and/or a recommendation for action for path planning and/or parameters for path planning and/or a traffic situation in the tunnel 490 and/or a possible entry into the tunnel 490 and/or a toll for using the tunnel 490, etc. For this purpose, the roadside radio unit 100 of the system 400 broadcasts a sequence of radio signals 401 by means of an antenna of a transmitting device 101. The broadcast radio signals 401 represent the information to be exchanged. The radio signals 401 additionally each comprise a temporal assignment and are broadcast in a specified time sequence by means of the transmitting device 101 of the roadside radio unit 100. The stationary monitoring unit 200 receives the sequence of radio signals 401 of the roadside radio unit 100 by means of a corresponding antenna. It may happen that, due to poor weather conditions and/or shadowing by other foreign vehicles, such as trucks, and/or a fault of the transmitting device 101, the monitoring unit 200 faultily receives or does not receive at least one expected radio signal of the sequence of radio signals 401 by means of the receiving device 201. The computing unit 204 of the monitoring unit 200 recognizes the expected and faulty or not-received radio signal and thereupon sends the response signal 402 to the roadside radio unit 100 by means of the transmission interface 202 and the cable 190. The roadside radio unit 100 subsequently generates a repeated signal by means of the transmitting device 101 as a function of the received response signal 402, wherein the repeated signal represents the not-received radio signal and is preferably marked as a repeated signal. The marking takes place, for example, by a label which represents “resent or sent multiple times.” Preferably, the repeated signal is transmitted to the vehicle 300 at a different radio frequency or by means of a mobile radio connection via a locally remote server device 410 so that another transmission error of the wireless direct communication between the vehicle 300 and the roadside radio unit 100 is unlikely since a different transmission mode is used.

FIG. 4B schematically shows a second system example of the system 400. Compared to the example of FIG. 4A, the system 400 in this example does not comprise a stationary monitoring unit 200. Instead, the vehicle 300 comprises the monitoring unit 310. The vehicle 300 is configured, by means of the monitoring unit 310, to recognize a not-received radio signal of the sequence of radio signals 401 and to broadcast a response signal 403 to the roadside radio unit 100. In this example, the transmission of the response signal 403 preferably takes place by means of a transmitting unit 303 of the vehicle 300 for a mobile radio connection to a server unit 410. The server unit 410 subsequently preferably sends the response signal 403 to the roadside radio unit 100 by means of a mobile radio connection. Subsequently, the roadside radio unit 100 is configured to broadcast the repeated signal to the vehicle 300, wherein the repeated signal is transmitted or broadcast as a WLANp radio signal or as a mobile radio signal.

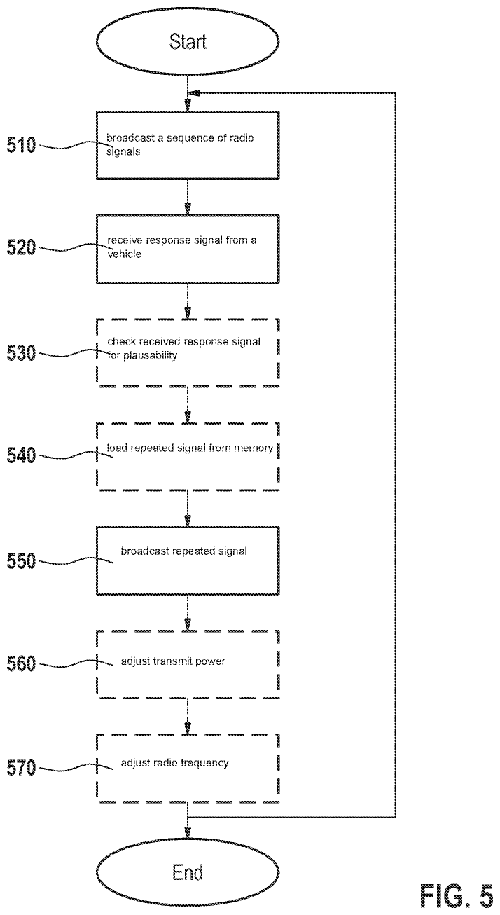

FIG. 5 schematically shows a flow of the method for securing wireless direct communication as a block diagram. The method begins with broadcasting 510 a sequence of radio signals 401 to the surroundings by means of the roadside radio unit 100. The radio signals 401 each have a temporal assignment and are preferably broadcast in a specified time sequence. Preferably, the radio signals 401 comprise additional information for supporting the vehicle or for V2X communication. Subsequently, in step 520, the roadside radio unit 100 receives a response signal 402, 403 from a vehicle 300 or a stationary monitoring unit 200. The response signal 402, 403 represents at least the temporal assignment of a radio signal that was faultily or not received by the vehicle 300 or by the monitoring unit 200. In an optional step 530, it may be provided that the received response signal 402, 403 is checked for plausibility based on the time of reception of the response signal 402, 403 and/or the temporal assignment of the not-received radio signal. Subsequently, the repeated signal is optionally loaded 540 from the memory 104 of the roadside radio unit 100 as a function of the response signal 402, 403. Alternatively, the last broadcast radio signal is used as the repeated signal. In step 550, the repeated signal is broadcast by means of the roadside radio unit 100 as a function of the received response signal 402, 403, wherein the repeated signal represents the faultily received or not-received radio signal and is marked as a repeated signal. The repeated signal is advantageously broadcast 550 with an increased transmit power in comparison to the radio signal. Optionally, the repeated signal is broadcast 550 at a different radio frequency or by means of a mobile radio connection via a server unit 410 to the vehicles 300 or the vehicle 300. In the subsequent optional step 560, it may be provided that a transmit power for broadcasting 510 the sequence of radio signals 401 to the surroundings is adjusted as a function of the received response signal 402, 403. Furthermore, in an optional step 570, it may be provided to adjust the radio frequency for broadcasting the sequence of radio signals 401 to the surroundings as a function of the received response signal 402, 403 or to broadcast the sequence of radio signals 401 as a function of the response signal 402, 403 by means of a mobile radio connection to a server unit 410. The method is preferably carried out in continuous repetition.

1-21. (canceled)

22. A method for securing communication between a roadside radio unit and vehicles in surroundings of the roadside radio unit, the method comprising the following steps:
broadcasting a sequence of radio signals to the surroundings using the roadside radio unit, wherein each of the radio signals has a temporal assignment;
receiving a response signal from a vehicle or a stationary monitoring unit, wherein the response signal represents at least the temporal assignment of a radio signal of the radio signals that was faulty or not received by the vehicle or by the monitoring; and
broadcasting a repeated signal using the roadside radio unit as a function of the received response signal, wherein the repeated signal represents the faulty or not-received radio signal and is marked as a repeated signal.

23. The method according to claim 22, wherein the reception of the response signal is checked for plausibility based on a time of the reception of the response signal and/or the temporal assignment of the faulty or not-received radio signal.

24. The method according to claim 22, wherein the repeated signal is loaded from a memory of the roadside radio unit as a function of the response signal.

25. The method according to claim 22, wherein a last broadcast radio signal is sent as the repeated signal.

26. The method according to claim 22, wherein the repeated signal is broadcast with an increased transmit power in comparison to the broadcast of the sequence of radio signals.

27. The method according to claim 22, wherein the transmit power for broadcasting the sequence of radio signals to the surroundings is adjusted as a function of the received response signal.

28. The method according to claim 22, wherein the repeated signal is broadcast with a different modulation method or a different resource block in semi-persistent scheduling.

29. The method according to claim 22, wherein the repeated signal is broadcast at a different radio frequency or using a mobile radio connection to a server unit.

30. The method according to claim 22, wherein a radio frequency for broadcasting the sequence of radio signals to the surroundings is adjusted as a function of the received response signal or the sequence of radio signals are broadcast using a mobile radio connection to a server unit.

31. The method according to claim 22, wherein the roadside radio unit is restarted, or switched off, or problem information is automatically sent to a server unit, as a function of the response signal or of a sequence of response signals of the monitoring unit or of the vehicle.

32. A non-transitory computer-readable medium on which is stored a computer program including instructions for securing communication between a roadside radio unit and vehicles in surroundings of the roadside radio unit, the instructions, when executed by a computer, causing the computer to perform the following steps:
broadcasting a sequence of radio signals to the surroundings using the roadside radio unit, wherein each of the radio signals has a temporal assignment;
receiving a response signal from a vehicle or a stationary monitoring unit, wherein the response signal represents at least the temporal assignment of a radio signal of the radio signals that was faulty or not received by the vehicle or by the monitoring; and
broadcasting a repeated signal using the roadside radio unit as a function of the received response signal, wherein the repeated signal represents the faulty or not-received radio signal and is marked as a repeated signal.

33. A system for supporting vehicles, comprising
a roadside radio unit, wherein the roadside radio unit is configured to:
i. broadcast radio signals with a temporal assignment using a transmitting device,
ii. receive, using a mobile-radio-based, or radio-based, or cable-based reception interface, a response signal from a vehicle or a monitoring unit, wherein the response signal represents at least the temporal assignment of a radio signal of the radio signals that was faultily or not received by the vehicle or the monitoring unit, and
iii. broadcast a repeated signal using the transmitting device as a function of the received response signal, wherein the repeated signal represents the faulty or not-received radio signal and is marked as a repeated signal.

34. The system according to claim 33, further comprising:
the vehicle and/or the monitoring unit, wherein the vehicle and/or the monitoring unit is configured to:
i. receive the broadcast radio signals of the roadside radio unit using a receiving device, and
ii. send, based on a radio signal expected in the specified time sequence not being received, the response signal, at least comprising the temporal assignment of the not-received radio signal, to the roadside radio unit using a radio-based or cable-based transmission interface, or using a mobile radio connection to a server unit.

35. The system according to claim 33, wherein the roadside radio unit is configured to check the response signal for plausibility based on a time of reception of the response signal and/or the temporal assignment of the not-received radio signal, using a computing unit.

36. The system according to claim 33, wherein the roadside radio unit is configured to load the repeated signal from a memory of the roadside radio unit as a function of the response signal.

37. The system according to claim 33, wherein the transmitting device of the roadside radio unit is configured to broadcast the repeated signal with an increased transmit power in comparison to the broadcast of the radio signals.

38. The system according to claim 33, wherein the transmitting device of the roadside radio unit is configured to adjust a transmit power for broadcasting the sequence of radio signals to surroundings as a function of the received response signal.

39. The system according to claim 33, wherein the transmitting device of the roadside radio unit is configured to broadcast the repeated signal at a different radio frequency in comparison to the broadcast of the radio signals or to send the repeated signal to a server unit using a mobile radio connection.

40. The system according to claim 33, wherein the transmitting device of the roadside radio unit is configured to adjust a radio frequency for broadcasting the sequence of radio signals to surroundings as a function of the received response signal or to send the sequence of radio signals using a mobile radio connection to a server unit as a function of the received response signal.

41. A method for monitoring a roadside radio unit, the method comprising the following steps:
receiving a sequence of radio signals from a roadside radio unit, wherein each of the received radio signals has at least one temporal assignment;
recognizing a faulty or not-received radio signal at least based on a temporal assignment of the radio signals; and
generating a response signal, wherein the response signal represents at least the temporal assignment of the recognized, faulty or not-received radio signal.

42. A monitoring unit, comprising:
a receiver configured to receive a sequence of broadcast radio signals;
a computing unit configured to recognize, at least based on a temporal assignment of the radio signals, whether a radio signal was faultily or not received; and
a transmitter configured to generate a response signal, wherein the response signal represents at least one temporal assignment of the not-received or faultily received radio signal.
